(19) United States
(12) Patent Application Publication
(10) Pub. No.: US 2011/0282511 A1
(43) Pub. Date: Nov. 17, 2011

(54) Prediction, Communication and Control System for Distributed Power Generation and Usage

(75) Inventor: Richard Thomas Unetich, Chicago, IL (US)

(73) Assignee: SMART POWER DEVICES LTD, Chicago, IL (US)

(21) Appl. No.: 13/072,708

(22) Filed: Mar. 26, 2011

Related U.S. Application Data
(60) Provisional application No. 61/317,922, filed on Mar. 26, 2010.

(51) Int. Cl. G06F 1/32; G06F 1/30; G06F 17/00

(52) U.S. Cl. 700/296; 705/412; 700/297

(57) ABSTRACT

A system for predicting, communicating, displaying and utilizing data that is relevant to the distributed power generation and usage of electricity service via means that are easy to obtain, easy to interpret, and inexpensive.

### PRIORITY CLAIM/RELATED APPLICATIONS

This application claims priority under 35 USC 119(e) to U.S. Provisional Patent Application Ser. No. 61/317,922 filed on Mar. 26, 2010 and entitled “Prediction, Communication and Control System for Distributed Power Generation and Usage”, which is incorporated herein by reference in its entirety.

### BACKGROUND OF THE INVENTION

Smart Grid Initiative programs are being implemented both domestically and internationally in an effort to decrease total impact on the environment and to reduce peak loads on electrical grids with supplies that are both limited and variable in terms of total capacity. Consumers in home, commercial, and industrial sites can be involved in a number of different Smart Grid programs, depending on such factors as their geographic location, weather patterns in that location, zoning regulations, electricity services available to them, and personal preferences.

Net Metering is an increasingly popular Smart Grid program through which consumers are able to contribute electricity from their own energy sources back into the Smart Grid. Typically, at the end of the billing cycle, such consumers are charged for their total or net usage of electricity, just a subtraction of the contribution of their energy sources from their total usage. The compensation rate for each unit of energy contributed may be fixed or it can vary, depending on electricity market factors, such as in Market Rate Net Metering programs. Typically the kilowatt-hour (kW·h) is the unit of energy used for measuring consumption of loads and contribution of the customer's energy sources. The sources that such customers can own and operate may be photovoltaic (PV) solar cells, windmills, hydroelectric, or home fuel cells. The output levels of these sources may however also vary, as they can be dependent on weather or other conditions out of the customer's control.

Another Smart Grid program that is growing in popularity is Demand Response. Customers who participate in Demand Response programs are encouraged to minimize electricity usage at critical times with economic incentives in the billing for their service. Four such programs in the U.S. are Time Of Use pricing (TOU), Critical Peak Pricing (CPP), Peak Time Rebate (PTR), and Real Time Pricing (RTP). For the TOU system, customers are charged different rates in predefined time windows each day. On the CPP system, a set number of peak load and or low supply days each month will have expensive rates for enrolled customers. On the PTR system, enrolled customers pay fixed rates for electricity service but during certain peak load periods, they can receive rebate credits on their accounts for minimizing use. On the RTP system, the customers' usage charges change over predefined time increments (usually hourly) depending on wholesale electricity market prices.

The Smart Grid Initiative Net Metering and Demand Response programs have the potential to improve the reliability and capacity of electricity grids while providing environmental benefits as well. Across all types of Smart Grid Initiatives, however, customer education, awareness, interest, and involvement present challenges both to electricity providers and to consumers. In particular, critical information pertaining to electricity markets, need of generation, ability of a customer's generation of electricity, and other parameters pertaining to customer participation in both Demand Response and Market Rate Net Metering programs is complex and expensive to communicate, can be difficult to interpret, and is often inaccurate with respect to final needs of Net Metering and Demand Response programs that were valid for any given moment in time. Smart Grid Initiatives can thus not fully succeed in their efforts to lower costs, conserve energy, and reduce emissions into the environment.

Consequently, there exists a need for a system that predicts, communicates and utilizes accurate and relevant data to customers on both Net Metering and Demand Response programs continuously, simply and inexpensively.

### SUMMARY OF THE INVENTION

The current invention provides a system that communicates data that is both accurate, with respect to what end use customers are billed for their electricity generation or usage, complete in terms of its usefulness relative to generation needs, capabilities and expected usage levels, and simple to interpret, allowing consumers and possibly their own generators or devices on the system to better participate in Net Metering and Demand Response programs.

The server computer functions subsequently described could be implemented on a centralized server that obtains information from other sources and then transmits data to the customers' client devices on the system, or they could be implemented separately in each client, or they could be implemented on one server that relays data to one or more other servers capable of handling large amounts of client traffic. For the purpose of this document, however, they will be described as being on a single server computer that collects information, generates data and transmits it to numerous client devices, illustrated in FIG. 1.

The server computer performs Smart Price Predictions on effective electricity market conditions by gathering existing data from a computer network, most likely the Internet, and performing mathematical calculations on that data to better predict the final prices that will apply to consumers, as generators or users of electricity. The server also gathers present and forecasted weather information (data that is usually critical both for capability of generation and for market prediction) to formulate Smart Generation Figures for use by customers who generate electricity fed into the Smart Grid. Additionally, the server generates Smart User Prediction data, based on past and present user electricity usage and generation levels of the individual consumers, if they so desire. The client devices on the same computer network then acquire from the server the Smart data applicable to their region, market, and personal generation and utilization levels, then display it to the user. The client devices display information to users that can convey a possible need for enabling generation on the consumers' part and the predicted price levels for their generation and usage. The devices can also possibly automatically enable the users' generation systems or possibly also utilize the data to control the users' own loads or electronic devices that can be automatically enabled or disabled based on user-definable price thresholds, a range of thresholds, or conditional thresholds.

### DRAWING DESCRIPTIONS

FIG. 1: System diagram showing raw data, server computer and client devices.

FIG. 2: Plot of forms of price data vs. hour of the day. Example data and labels included.

FIG. 3: Client device with USB data and power connections.

FIG. 4: Client device connector diagram and pin functions.

FIG. 5: Client device with integrated switching power outlet.

FIG. 6: Client device with integrated thermostat functions.

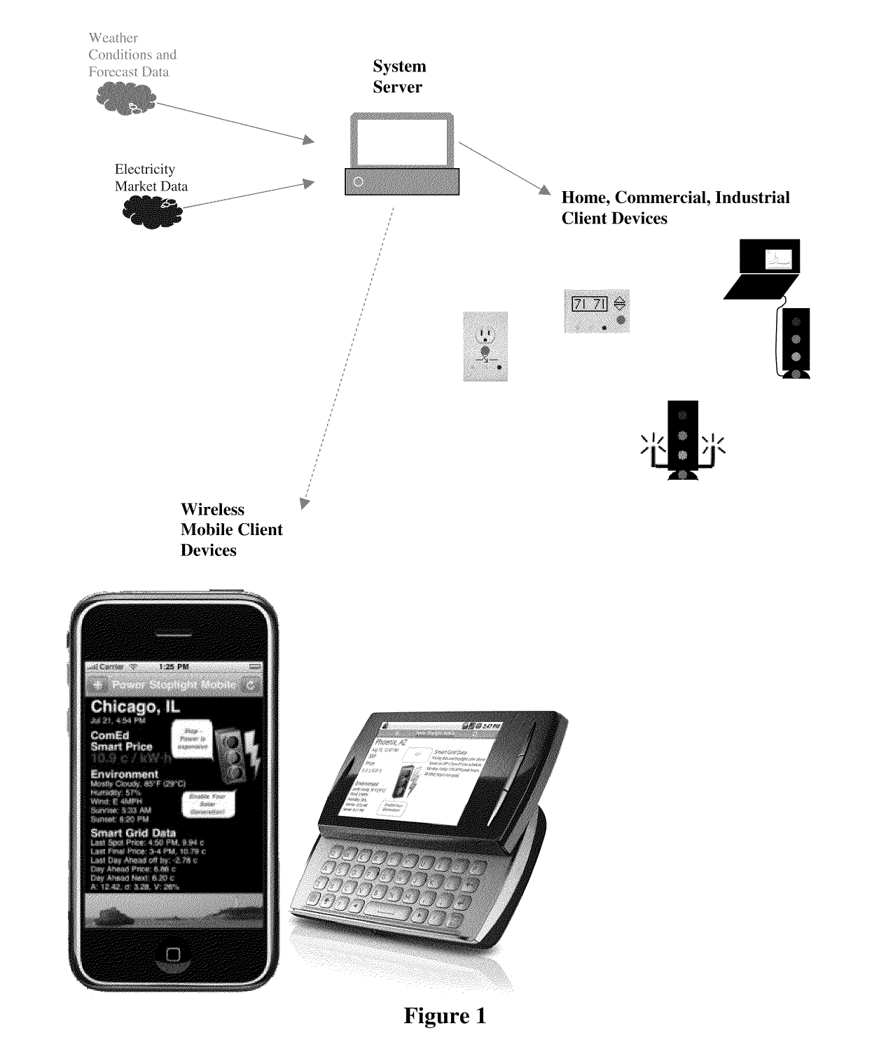

### DETAILED DESCRIPTION OF THE INVENTION

The server computer in this system constantly monitors electrical grid market data and generates predicted price information that can be communicated to customers on both Net Metering and Demand Response programs as Time Of Use, Critical Peak Pricing, Peak Time Rebate, and Real Time Pricing. Of particular interest and challenge though is the prediction of accurate price information for customers on Market Rate Net Metering and Real Time Pricing programs where constantly changing market prices determine end prices that are applied to customers after their own generation and usage occurs. This market system is known as Locational Market Pricing (LMP) and is coordinated in the United States by several Regional Transmission Organizations (RTOs). For consumers on Market Rate Net Metering and Real Time Pricing programs, this LMP data as it evolves determines their variable electricity rates, usually hourly, by averaging a set number of variable Spot Prices that come from the market during that hour. Another piece of data that is usually available for LMP is Day Ahead pricing, a forecast set of prices based on the market's expected supply and demand balances over the course of the following day. Though these pieces of information can be obtained by the user while or in advance of their final rates are being determined, gathering those figures can be difficult to do, but more importantly, both sets of numbers can be misleading to consumers due to inaccuracies between them and the final electricity rates that apply to consumers' electricity generation and usage.

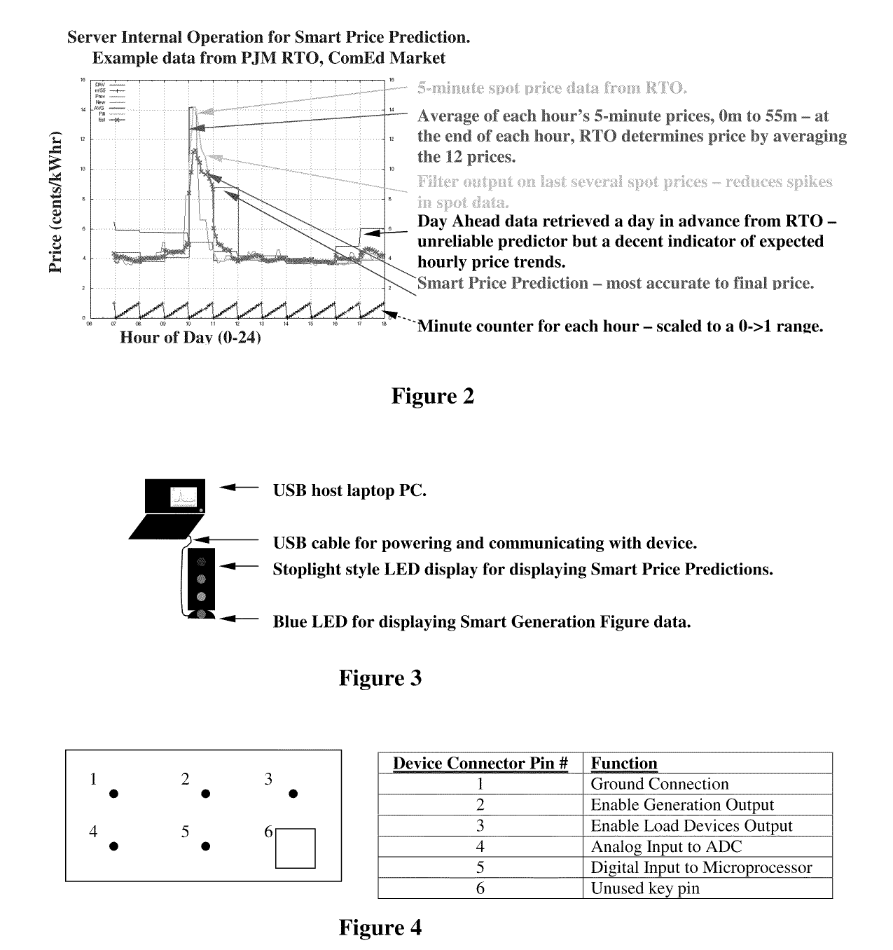

The server presented in this system, instead of relaying the raw Spot Prices or Day Ahead price information, generates and communicates more accurate Smart Price Predictions by performing a variable weighted average calculation on the Day Ahead data, existing Spot Prices for the present hour, and a low pass filter output on the last several Spot Prices, as shown in FIG. 2. To more accurately predict prices, the system implements dynamic changes on the weighting of these parameters based on the hour of the day, minute of the hour, previous price, accuracy of the previous price relative to the Day Ahead figure for that hour, and accuracy of the weather forecast relative to the actual temperature that day, which can have significant effect in the summer when many customers are using high-load air conditioning systems.

Alternatively, a neural network method could be implemented to use Day Ahead, Spot Price, and weather forecast data as input parameters from which it would predict the remaining unknown Spot Prices in any given hour, and thus perform Smart Price Prediction on the final prices, especially considering the significant sets of past market data available to train a neural network.

The server computer also generates parameters called Smart Generation Figures, a measure for indicating the level of both need and capability for Net Metering customer involvement in generation of electricity. The Smart Generation Figures follow an inverse relation to pricing on electricity markets for which customers will be compensated based on their Market Rate Net Metering programs and follows a direct relation to a factor that gauges if generation on their part and with their generation technology may be possible at the present time or in the near future.

Weather conditions and forecast data, as previously mentioned for predicting market levels, are gathered by the server, but are additionally processed by the server to determine Smart Generation Figures. For example, sunrise and sunset times of day as well as levels of sunlight available for a particular region that day are critical data for the generation of solar energy for client devices or users with photovoltaic panels that are fragile in nature and sensitive to dirt and debris, so they are often covered for their protection in low light conditions. Similarly, wind speed and direction are very useful pieces of information for wind power generation in that if no wind is expected at a given time and place, it is preferable to disable or take such equipment offline.

Lastly, the server computer also obtains data that is more personalized for each user pertaining to their past, present and predicted generation and usage levels of energy. This Smart User Prediction data is however not always obtainable in real time due to the type of Smart Meter and infrastructure in place for each client or it may seem intrusive to customers, in which case it could possibly be part of a process running at the client device locations, or it could be opted out with the anonymized user's devices still having functionality.

The server makes the Smart Generation Figures, Smart Price Predictions, Smart User Predictions and other relevant data available to client devices on the shared computer network via standard Internet formats such as HTML, XML, RSS, and Push.

To restrict access to the data generated by the server, as an alternative to standard protection approaches such as login or site certificates, the server can change the filenames of its generated data according to a pseudo-random numeric sequence encoding on the present date and time, which client devices implement as well to obtain the server data.

The client devices in the system can obtain the data from the server through either wired or wireless connections to the shared computer network, most likely the Internet, to which a growing number of customers already have access. The most expensive and elaborate smart meters and infrastructures capable of full two-way communication are thus not required for the system in this invention to succeed in the Net Metering and Demand Response programs, from both the electricity providers' and consumers' perspectives. This is key, considering that many end-use smart meters and grids are not capable of even one-way communication in real-time.

The client device depicted in FIG. 3 requires no external power supply and connects to a Universal Serial Bus (USB) port on a customer's computer, ideally a low power laptop or a PC using power management functions to limit consumption of the monitor, hard drive and other internal devices. It can be wall mounted or placed on a table or desk up to 16 feet away from the host computer, but USB hubs can extend the range further. This device contains a programmable low cost microprocessor that controls output pins for power generation enabling and for load management and drives Light Emitting Diodes (LED's) that indicate the user's relevant Smart Generation Figure and Smart Price Prediction data The devices obtains this information from the system server along with the user's Smart User Prediction data. The device is very low cost (less than $5 component cost) as its major components are the device casing and a USB-capable microcontroller.

The device's display LED's are positioned in multiple places on the device which may have a translucent casing for maximum visibility to the user from far away, with more detailed information available on the USB host PC monitor. The display LED's are Pulse Width Modulation (PWM) controlled by the microcontroller to vary their individual brightness levels. As shown in FIG. 3, the display indicates the Smart Generation Figure to power generating consumers with a Blue LED, for example, an appropriate color to indicate clear skies and sunny weather at present or in the near future for solar power generating customers, but an applicable indicator as well for generators of wind derived or other energy sources. The intensity or brightness of the Blue LED can be varied to indicate different degrees of their Smart Generation Figure, or the LED can be pulsed or blinked to indicate similar information.

The device also has, for example, three Smart Price Prediction LED's that can be Red, Yellow, and Green in color and which follow a familiar stoplight type coding where Red indicates a high Price, Yellow indicates intermediate, and Green indicates low.

The PWM capabilities of the microcontroller could be used to convey more detail to the customer, by blinking or pulsating the LED's per specific Smart Price Prediction levels, for example and by default:

| Smart Price (cents/kW · h) | Stop Light LED's |
|---|---|
| >20 | Red Blinking |
| 14->20 | Red Pulsating |
| 10->14 | Red |
| 8->10 | Yellow Pulsating |
| 6->8 | Yellow |
| 4->6 | Green Pulsating |
| 1->4 | Green |
| <1 | Green Blinking |

With the Blue LED indicating the Smart Generation Figure and the stoplight coding for conveying the Smart Price Prediction data, for example, any individual in a household, factory, or office could thus easily interpret this Power Stoplight device, not just the purchaser, and the universal interface would be common for the device across residential, industrial, and commercial usage domains, as well as across all electricity market regions.

The LED's for indicating Smart Price Prediction data can alternatively be Red, Green, and Blue (RGB) LED's that are color-blended from 8-bit intensity levels, thus capable of displaying any of 1.7 Million colors. A color wheel ROYGBIV-type coding scheme could be chosen to indicate Smart Price Prediction data with Red being the highest, and Violet the lowest price threshold.

The PC software with the client device also allows for user configuration of audible alerts to sound at certain Smart Generation Figure and Smart Price Prediction thresholds or for advanced users to run specific PC or network commands at crossings of or during persistence of predefined thresholds. For example, an advanced user could configure the software with his device to shut down a system of networked computer servers at night if the Smart Price Prediction for electricity is above a certain threshold and if his own solar power generation capacity and need for such generation were low per the present Smart Generation Figure and Smart User Prediction data. In this case the device could also automatically disable his power generation equipment, through a logic level output on the device to cover or uncover the user's solar panels, which may accept such an input. This output signal can be configured by the user for enabling and disabling his generation systems that can accept external actuation or be retractable or coverable to protect from vandalism or other damage.

In addition to the LED's used for displaying the Smart Generation Figure and Smart Price Prediction data, an extra output and optional LED, probably white in color, can be used to power on or off light-enabled devices, appliances, or outlets that are commonly available at hardware stores or online vendors. The user can configure the illumination thresholds in the PC software for simple automatic control of possibly significant electrical loads at their own defined price thresholds, thus implementing Demand Side Management, another Smart Grid Initiative, of their electrical load devices at a very low cost. Or the user can use the same output as a logic control signal for enabling or disabling other electronic devices, asserted or cleared above or below their own Smart User Prediction definable price thresholds. This output signal could possibly drive a specific-frequency LED that is accompanied with a matched optical receiver, both provided by the user and not adding to the total product cost. Or the receiver device enabling a particular electrical load could be one of many, each of which is fixed at a separate frequency and the enabling output signal with an LED connected to it could output the correct enabling or disabling signals at each receiver frequency.

The above described logic level or optical-optional outputs for power generation and/or Demand Side Management come from parameters that are first established by the user on configuring his device through its control software guided setup routine. Guided setup determines parameters for operation and control of the device such as whether or not they are a participant in Net Metering, if that program is Market Rate Net Metering, what type of power generation (solar, wind, etc) they operate, if they are on a Demand Response participant, which type of Demand Response, and if they will participate in Demand Side Management of their electrical loads.

Guided setup of the device's control software also determines what kind of Smart User Prediction data applies to the customer or if the customer wishes the control program to access other information on the shared computer network, such as alternative energy prices for their hybrid car. If the shared computer network and the user have access to and the user chooses to share his own electricity generation and usage data, that information can be used by the control software to refine their Smart User Prediction data. Additionally, their data could follow a pattern, such as one established for an individual living in an apartment with a space heater to enable via an optical power control, one for a family of five persons living in the same large house, or one for a couple that owns an electric car which should recharge nightly.

Guided setup also allows for optional feedback selection on the user's Power Stoplight device status, for example if a user in a particular location is able to generate electricity from wind or solar energy, allowing for distributed feedback and data gathering to assist the server in calculating Smart data parameters. The Power Stoplight device has one available digital input and one analog input, shown on the device connector in FIG. 4. The analog input connects to an Analog to Digital Converter (ADC) in the microprocessor that is capable of reading a number of parameters, including temperature of the device, which could be useful to the server as well. The server could also possibly share it's Smart parameters and the distributed feedback data that it gathers from it's network of devices with RTO's, power companies, or with dedicated Demand Side Management operators.

Lastly, guided setup also determines what Smart Price Prediction threshold levels a particular user has for controlling the display Pricing and Generation LED's, for optionally enabling power generation systems that they may operate, and when to control their optionally controllable electrical loads through the logic level signal or the optical control outputs. The points in time at which they enable and disable generation or loads may not be exactly tied to a one specific Smart Price Prediction level but to a threshold range or to a conditional threshold, i.e. parameters that dynamically change the threshold levels for enabling and disabling a particular load which for example the user may need to do for a particular amount of time and at a certain power level, as in the case of charging the electric car overnight.

In other words, the device LED's and outputs can be configured to indicate or control based on the Smart Price Prediction, Smart Generation Figure, and Smart User Prediction data, that it is simply a good time for the consumer to generate or consume electricity, all relative to normal price levels in their electrical market, relative to their own instantaneous and average generation and usage levels. This is in effect trying to beat a spread by betting on certain price levels occurring at certain times and for certain durations and some customer's generation and usage patterns or needs might fall into a category where they would want to do so, or they may not, as determined and established in guided setup.

The Bill Of Material (BOM) total cost of the previously described USB Power Stoplight is below $5.00 US, significantly less than the sale prices and expected BOM costs for other smart grid devices on the market, typically selling for over $100. The display of the device serves to inexpensively convey key information pertaining to Net Metering and Demand Response in an intuitive manner, but the user can view very detailed additional data on the host computer, such as their present power generation and consumption levels, the active Smart parameters, or recent and forecasted market and weather data. The device itself additionally requires no internal radio transmitter or receiver and the smart grid for which this device provides data is not required to provide complex information in real-time to consumers, saving significant cost and development on the RTO and electricity company sides as well.

Components in the Power Stoplight device BOM and their prices are as follows:

| Component | Cost |
|---|---|
| Flash Programmable Microprocessor | $1.45 |
| with USB interface | |
| Mini-USB connector | $0.62 |
| Red LED | $0.08 |
| Yellow LED | $0.08 |
| Green LED | $0.08 |
| Blue LED | $0.40 |
| Plastic housing | $0.85 |
| Printed Circuit Board | $0.75 |
| Resistors (4), Capacitors (2) | $0.12 |
| Crystal for microprocessor oscillator circuit | $0.45 |
| Total | $4.88 |

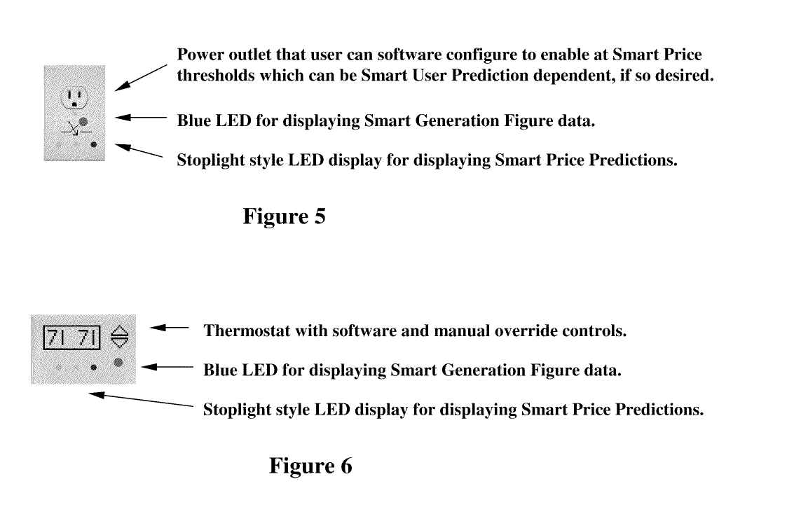

The client display devices could alternatively have other display options such as a liquid Crystal Display (LCD) or Organic LED (OLED) screen, or other connectivity options to access the server's predicted price data, such as direct Ethernet into a LAN through which it would get data from the server computer, wirelessly via Wi-Fi (IEEE 802.11B/G/N), wireless USB, Zigbee, or even on a mobile network. It can additionally have the hardware and capability to switch on & off power outlets on which the user would connect devices that they wish to power above or below their own definable Smart Price thresholds and per their Smart User Prediction data, as shown in FIG. 5. The display could be combined with thermostat functions, as shown in FIG. 6. A customer using such a device would again via software be able to configure the device for Smart Price thresholds and Smart User Prediction data along with calendar functions and temperature settings to address the complex tradeoffs between cost savings on significant Air Conditioning loads vs. consumer comfort, providing controls on the device for manual override.

The client display devices can also be used to display other types of data to consumers, instead of or in addition to electricity service Smart data. Other information feeds that can be directed to the device are data such as stock or portfolio values, weather forecasts, sports scores, computer network status, traffic reports, or calendar appointments.

The wireless mobile client devices as part of this system run software applications that, similar to the hardware display device, periodically obtain and then show electricity price predictions to consumers in an easy to interpret manner and are very inexpensive (less than $5 predicted sale price). From the home screen of the device, an icon shows a simple Smart Generation and Smart Price indicator. Opening the application shows more detail as on the PC software, such as past and future Smart Price Predictions and Smart Generation Figures. Audible and vibration alerts at user-definable thresholds are also configurable.

Another class of separate client devices for the Smart data system in this invention is that of devices, systems, or vehicles that require charging of large batteries, something potentially very expensive for consumers. While connectivity to a computer network may be built in to the device and allow some level of remote control on the charging of these devices, a Smart Price, Smart Generation and Smart User Prediction system that manages their charging control could help users of such devices. For example, the owner of an electric car in need of charging may also own and manage separate power generation sources, which could at certain times be better fed back into the Smart Grid and then subsequently be used for charging the vehicle. Both the user participating in the Smart Grid Initiatives and the Grid itself would benefit in this situation, as well as many other devices that can utilize the system in this invention.

I claim as my invention:

1. In a distributed power generation and usage environment in which the price of a utility is not always completely determined at the time of use, an apparatus for obtaining, interpreting and communicating to a user reliable and predictive information that is relevant to the price of electricity service at a prospective time with said utility. Said apparatus comprises means for communicating, means for processing, and means for displaying data.

2. The apparatus of claim 1 further comprising weighted average calculations for predicting price information.

3. The apparatus of claim 1 further comprising neural network calculations for predicting price information.

4. The apparatus of claim 1 further comprising the communication of price information.

5. The apparatus of claim 1 further comprising the display of price information.

6. The apparatus of claim 1 further comprising the display of data indicative of a user's ability to generate power to be returned to the electricity grid.

7. The apparatus of claim 1 further comprising the display of data indicative of an electricity grid's need of a user to generate power to be returned to the electricity grid.

8. The apparatus of claim 1 through which the display element can optically enable electrical load devices at optimal times with respect to electricity price information.

9. The apparatus of claim 1 through which the display element can optically enable electrical load devices at optimal times with respect to electricity price information.

10. The apparatus of claim 1 through which the display element can optically enable electrical power generation devices at optimal times with respect to a user's ability to generate power.

11. The apparatus of claim 1 through which the display element can optically enable electrical power generation devices at optimal times with respect to electricity grid needs.

12. The apparatus of claim 1 that requires no external power supply, connects to a Universal Serial Bus (USB), implements Pulse Width Modulation (PWM) for indication and optical enabling of load and generation equipment, and has audible alerts for user interaction if so desired.

13. The apparatus of claim 1 that communicates wirelessly via Wi-Fi, Zigbee, Wireless USB, or through mobile networks to implements Pulse Width Modulation (PWM) for indication and optical enabling of load and generation equipment, and has audible alerts for user interaction if so desired.
